(19) United States
(12) Patent Application Publication
(10) Pub. No.: US 2006/0015329 A1
(43) Pub. Date: Jan. 19, 2006

(54) Apparatus and method for audio coding

(76) Inventor: Wai C. Chu, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/184,348

(22) Filed: Jul. 18, 2005

Related U.S. Application Data
(60) Provisional application No. 60/589,286, filed on Jul. 19, 2004.

(51) Int. Cl. G10L 19/08

(52) U.S. Cl. 704/219

(57) ABSTRACT

A method and apparatus for coding information are described. In one embodiment, an encoder for encoding a first set of data samples comprises a waveform analyzer to determine a set of waveform parameters from a second set of data samples, a waveform synthesizer to generate a set of predicted samples from the set of waveform parameters; and a first encoder to generate a bit-stream based on a difference between the first set of data samples and the set of predicted samples.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### PRIORITY

The present patent application claims priority to the corresponding provisional patent application Ser. No. 60/589,286, entitled “Method and Apparatus for Coding Audio Signals,” filed on Jul. 19, 2004.

### FIELD OF THE INVENTION

The present invention relates to the field of signal coding; more particularly, the present invention relates to coding of waveforms, such as, but not limited to, audio signals using sinusoidal prediction.

### BACKGROUND OF THE INVENTION

After the introduction of the CD format in the mid eighties, a flurry of application that involved digital audio and multimedia technologies started to emerge. Due to the need of common standards, the International Organization for Standardization (ISO) and the International Electro-technical Commission (IEC) formed a standardization group responsible for the development of various multimedia standards, including audio coding. The group is known as Moving Pictures Experts Group (MPEG), and has successfully developed various standards for a large array of multimedia applications. For example, see M. Bosi and R. Goldberg, Introduction to Digital Audio Coding and Standards, Kluwer Academic Publishers, 2003.

Audio compression technologies are essential for the transmission of high-quality audio signals over band-limited channels, such as a wireless channel. Furthermore, in the context of two-way communications, compression algorithms with low delay are required.

An audio coder consists of two major blocks: an encoder and a decoder. The encoder takes an input audio signal, which in general is a discrete-time signal with discrete amplitude in the pulse code modulation (PCM) format, and transforms it into an encoded bit-stream. The encoder is designed to generate a bit-stream having a bit-rate that is lower than that of the input audio signal, achieving therefore the goal of compression. The decoder takes the encoded bit-stream to generate the output audio signal, which approximates the input audio signal in some sense.

Existing audio coders may be classified into one of three categories: waveform coders, transforms coders, and parametric coders.

Waveform coders attempt to directly preserve the waveform of an audio signal. Examples include the ITU-T G.711 PCM standard, the ITU-T G.726 ADPCM standard, and the ITU-T G.722 standard. See, for example, W. Chu, Speech Coding Algorithms: Foundation and Evolution of Standardized Coders, John Wiley & Sons, 2003. Generally speaking, waveform coders provide good quality only at relatively high bit-rate, due to the large amount of information necessary to preserve the waveform of the signal.

That is, waveform coders require a large amount of bits to preserve the waveform of an audio signal and are thus not suitable for low-to-medium-bitrate applications.

Other audio coders are classified as transform coders, or subband coders. These coders map the signal into alternative domains, normally related to the frequency content of the signal. By mapping the signal into alternative domains, energy compaction can be realized, leading to high coding efficiency. Examples of this class of coders include the various coders of the MPEG-1 and MPEG-2 families: Layer-I, Layer-II, Layer-III (MP3), and advanced audio coding (AAC). M. Bosi and R. Goldberg, Introduction to Digital Audio Coding and Standards, Kluwer Academic Publishers, 2003. These coders provide good quality at medium bit-rate, and are the most popular for music distribution applications.

Also, transform coders provide better quality than waveform coders at low-to-medium bitrates. However, the coding delay introduced by the mapping renders them unsuitable for applications, such as two-way communications, where a low coding delay is required. For more information on transform coders, see T. Painter and A. Spanias, “Percerptual Coding of Digital Audio,” Proceedings of the IEEE, Vol. 88, No. 4, pp. 451-513, April 2000.

More recently, researchers have explored the use of models in audio coding, with the model controlled by a few parameters. By estimating the parameters of the model from the input signal, very high coding efficiency can be achieved. These kinds of coders are referred to as parametric coders. For more information on parametric coders, see B. Edler and H. Purnhagen, “Concepts for Hybrid Audio Coding Schemes Based on Parametric Techniques,” IEEE ICASSP, pp. II-1817-II-1820, 2002, and H. Purhagen, “Advances in Parametric Audio Coding,” IEEE Workshop on Applications of Signals Processing to Audio and Acoustics, pp. W99-1 to W99-4, October 1999. An example of parametric coder is the MPEG-4 harmonic and individual lines plus noise (HILN) coder, where the input audio signal is decomposed into harmonic, individual sine waves (lines), and noise, which are separately quantized and transmitted to the decoder. The technique is also known as sinusoidal coding, where parameters of a set of sinusoids, including amplitude, frequency, and phase, are extracted, quantized, and included as part of the bit-stream. See H. Purnhagen, N. Meine, and B. Edler, “Speeding up HILN—MPEG-4 Parametric Audio Encoding with Reduced Complexity,” 109th AES Convention, Los Angeles, September 2000, ISO/IEC, Information Technology—Coding of Audio-Visual Object—Part 3: Audio, Amendment 1: Audio Extensions, Parametric Audio Coding (HILN), 14496-3, 2000. An audio coder based on principles similar to that of the HILN can be found in a recent U.S. Patent Application No. 6,266,644, entitled, “Audio Encoding Apparatus and Methods”, issued Jul. 24, 2001. Other schemes following similar principles can be found in A. Ooment, A. Cornelis, and D. Brinker, “Sinusoidal Coding,” U.S. Patent Application No. U.S. 2002/0007268A1, published Jan. 17, 2002, and T. Verma, “A Perceptually Based Audio Signal Model with Application to Scalable Audio Compression,” Ph.D. dissertation—Stanford University, October 1999.

The principles of parametric coding have been widely used in speech coding applications, where a source-filter model is used to capture the dynamic of the speech signal, leading to low bit-rate applications. The code excited linear prediction (CELP) algorithm is perhaps the most successful method in speech coding, where numerous international standards are based on it. For more information on CELP, see W. Chu, Speech Coding Algorithms: Foundation and Evolution of Standardized Coders, John Wiley & Sons, 2003. The problem with these coders is that the adopted model lacks the flexibility to capture the behavior of general audio signals, leading to poor performance when the input signal is different from speech.

Sinusoidal coders are highly suitable for the modeling of a wide class of audio signals, since in many instances they have a periodic appearance in time domain. By combining with a noise model, sinusoidal coders have the potential to provide good quality at low bit-rate. All sinusoidal coders developed until recently operate in a forward-adaptive manner, meaning that the parameters of the individual sinusoids—including amplitude, frequency, and phase—must be explicitly transmitted as part of the bit-stream. Because this transmission is expensive, only a selected number of sinusoids can be transmitted for low bit-rate applications. See H. Purnhagen, N. Meine, and B. Edler, “Sinusodial Coding Using Loudness-Based Component Selection,” IEEE ICASSP, pp. II-1817-II-1820, 2002. Due to this constraint, the achievable quality of sinusoidal coders, such as the MPEG-4 HILN standard, is quite modest.

### SUMMARY OF THE INVENTION

A method and apparatus for coding information are described. In one embodiment, an encoder for encoding a first set of data samples comprises a waveform analyzer to determine a set of waveform parameters from a second set of data samples, a waveform synthesizer to generate a set of predicted samples from the set of waveform parameters; and a first encoder to generate a bit-stream based on a difference between the first set of data samples and the set of predicted samples.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a coding system.

FIG. 2 is a block diagram of one embodiment of an encoder.

FIG. 3 is a flow diagram of one embodiment of an encoding process.

FIG. 4 is a block diagram of one embodiment of a decoder.

FIG. 5 is a flow diagram of one embodiment of a decoding process.

FIG. 6A is a flow diagram of one embodiment of a process for sinusoidal prediction.

FIG. 6B is a flow diagram of one embodiment of a process for generating predicted samples from analysis samples using sinusoidal prediction.

FIG. 7 illustrates the time relationship between analysis samples and predicted samples.

FIG. 8A is a flow chart of one embodiment of a prediction process based on waveform matching.

FIG. 8B illustrates one embodiment of the structure of the codebook.

FIG. 9 is a flow diagram of one embodiment of a process for selecting a sinusoid for use in prediction.

FIG. 10 is a flow diagram of one embodiment of a process for making a decision as to the selection of a particular sinusoid.

FIG. 11 illustrates each frequency component of a frame being associated with three components from the past frame.

FIG. 12 is a block diagram of one embodiment of a lossless audio encoder that uses sinusoidal prediction.

FIG. 13 is a flow diagram of one embodiment of the encoding process.

FIG. 14 is a block diagram of one embodiment of a lossy audio encoder that uses sinusoidal prediction.

FIG. 15 is a block diagram of one embodiment of a lossless audio decoder.

FIG. 16 is a flow diagram of one embodiment of the decoding process.

FIG. 17A is a block diagram of one embodiment of an audio encoder that includes switched quantizers and sinusoidal prediction.

FIG. 17B is a flow diagram of one embodiment of an encoding process using switched quantizers.

FIG. 18A is a block diagram of one embodiment of an audio decoder that uses switched quantizers.

FIG. 18B is a flow diagram of one embodiment of a process for decoding a signal using switched quantizers.

FIG. 19A is a block diagram of one embodiment of an audio encoder that includes signal switching and sinusoidal prediction.

FIG. 19B is a flow diagram of one embodiment of an encoding process.

FIG. 20A is a block diagram of one embodiment of an audio decoder that includes signal switching and sinusoidal prediction.

FIG. 20B is a flow diagram of one embodiment of a process for decoding a signal using signal switching and sinusoidal prediction.

FIG. 21 is a block diagram of an alternate embodiment of a prediction generator that generates a set of predicted samples from a set of analysis samples.

FIG. 22 is a flow diagram describing the process for generating predicted samples from analysis samples using matching pursuit.

FIG. 23 is a block diagram of an example of a computer system.

### DETAILED DESCRIPTION OF THE PRESENT INVENTION

A method and apparatus is described herein for coding signals. These signals may be audio signals or other types of signals. In one embodiment, the coding is performed using a waveform analyzer. The waveform analyzer extracts a set of waveform parameters from previously coded samples. A prediction scheme uses the waveform parameters to generate a prediction with respect to which samples are coded. The prediction scheme may include waveform matching. In one embodiment of waveform matching, given the input signal samples, a similar waveform is found inside a codebook or dictionary that best matches the signal. The stored codebook, or dictionary, contains a number of signal vectors. Within the codebook, it is also possible to store some signal samples representing the prediction associated with each signal vectors or codevectors. Therefore, the prediction is read from the codebook based on the matching results.

In one embodiment, the waveform matching technique is sinusoidal prediction. In sinusoidal prediction, the input signal is matched against the sum of a group of sinusoids. More specifically, the signal is analyzed to extract a number of sinusoids and the set of the extracted sinusoids is then used to form the prediction. Depending on the application, the prediction can be one or several samples toward the future. In one embodiment, the sinusoidal analysis procedure includes estimating parameters of the sinusoidal components from the input signal and, based on the estimated parameters, forming a prediction using an oscillator consisting of the sum of a number of sinusoids.

In one embodiment, sinusoidal prediction is incorporated into the framework of a backward adaptive coding system, where redundancies of the signal are removed based on past quantized samples of the signal. Sinusoidal prediction can also be used within the framework of a lossless coding system.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

System and Coder Overview

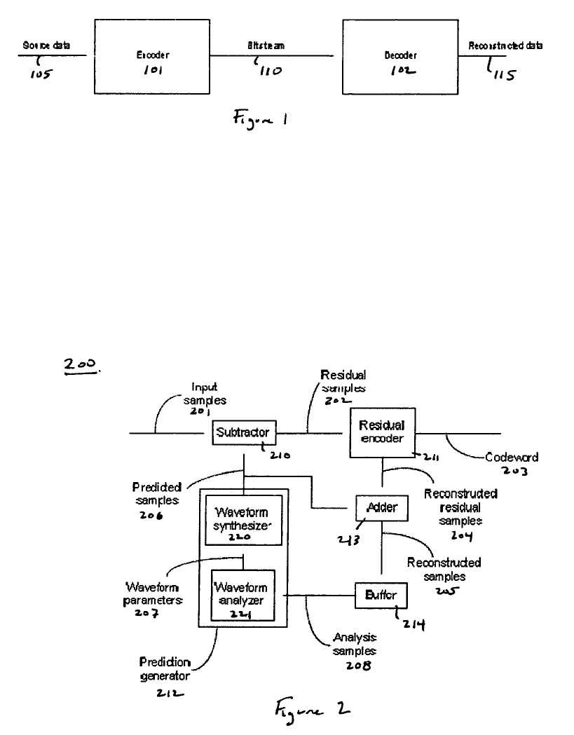

FIG. 1 is a block diagram of one embodiment of a coding system. Referring to FIG. 1, encoder 101 converts source data 105 into a bit stream 110, which is a compressed representation of source data 105. Decoder 102 converts bit stream 110 into reconstructed data 115, which is an approximation (in a lossy compression configuration) or an exact copy (in a lossless compression configuration) of source data 105. Bit stream 110 may be carried between encoder 101 and decoder 102 using a communication channel (such as, for example, the Internet) or over physical media (such as, for example, a CD-ROM). Source data 105 and reconstructed data 115 may represent digital audio signals.

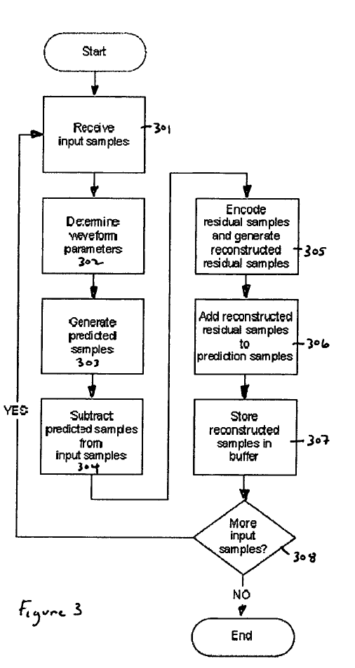

FIG. 2 is a block diagram of one embodiment of an encoder, such as encoder 101 of FIG. 1. Referring to FIG. 2, encoder 200 receives a set of input samples 201 and generates a codeword 203 that is a coded representation of input samples 201. In one embodiment, input samples 201 represent a time sequence of one or more audio samples, such as, for example, 10 samples of an audio signal sampled at 16 kHz. The audio signal may be segmented into a sequence of sets of input samples, and operation of encoder 200 described below is repeated for each set of input samples. In one embodiment, codeword 203 is an ordered set of one or more bits. The resulting encoded bit stream is thus a sequence of codewords.

More specifically, encoder 200 comprises a buffer 214 containing a number of previously reconstructed samples 205. In one embodiment, the size of buffer 214 is larger than the size of the set of input samples 201. For example, buffer 214 may contain 140 reconstructed samples. Initially, the value of the samples in buffer 214 may be set to a default value. For example, all values may be set to 0. In one embodiment, buffer 214 operates in a first-in, first-out mode. That is, when a sample is inserted into buffer 214, a sample that has been in buffer 214 the longest amount of time is removed from buffer 214 so as to keep constant the number of samples in buffer 214.

Prediction generator 212 generates a set of predicted samples 206 from a set of analysis samples 208 stored in buffer 214. In one embodiment, prediction generator 212 comprises a waveform analyzer 221 and a waveform synthesizer 220 as further described below. Waveform analyzer 221 receives analysis samples 208 from buffer 214 and generates a number of waveform parameters 207. In one embodiment, analysis samples 208 comprise all the samples stored in buffer 214. In one embodiment, waveform parameters 207 include a set of amplitudes, phases and frequencies describing one or more waveforms. Waveform parameters 207 may be derived such that the sum of waveforms described by waveform parameters 207 approximates analysis samples 208. An exemplary process by which waveform parameters 207 are computed is further described below. In one embodiment, waveform parameters 207 describe one or more sinusoids. Waveform synthesizer 220 receives waveform parameters 207 from waveform analyzer 221 and generates a set of predicted samples 206 based on the received waveform parameters 207.

Subtractor 210 subtracts predicted samples 206 received from prediction generator 212 from input samples 201 and outputs a set of residual samples 202. Residual encoder 211 receives residual samples 202 from subtractor 210 and outputs codeword 203, which is a coded representation of residual samples 202. Residual encoder 211 further generates a set of reconstructed residual samples 204.

In one embodiment, residual encoder 211 uses a vector quantizer. In such a case residual encoder 211 matches residual samples 202 with a dictionary of codevectors and selects the codevector that best approximates residual samples 202. Codeword 203 may represent the index of the selected codevector in the dictionary of codevectors. The set of reconstructed residual samples 204 is given by the selected codevector. In an alternate embodiment, residual encoder 211 uses a lossless entropy encoder to generate codeword 203 from residual samples 202. For example, the lossless entropy encoder may use algorithms such as those described in “Lossless Coding Standards for Space Data Systems” by Robert F. Rice, 30ₜₕ Asilomar Conference on Signals, Systems and Computers, Vol. 1, pp. 577-585, 1996. In one embodiment, reconstructed residual samples 204 are equal to residual samples 202.

Encoder 200 further comprises adder 213 that adds reconstructed residual samples 204 received from residual encoder 211 and predicted samples 206 received from prediction generator 212 to form a set of reconstructed samples 205. Reconstructed samples 205 are then stored in buffer 214.

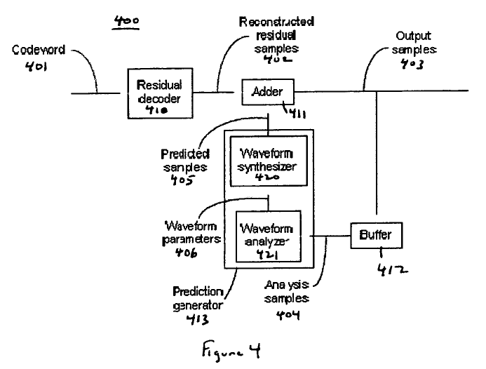

FIG. 3 is a flow diagram of one embodiment of an encoding process. The process is performed by processing logic that may comprise hardware (e.g., circuitry, dedicated logic, etc.), software (such as is run on a general purpose computer system or a dedicated machine), or a combination of both. Such an encoding process may be performed by encoder 200 of FIG. 2.

Referring to FIG. 3, the process begins by processing logic receiving a set of input samples (processing block 301). Then, processing logic determines a set of waveform parameters based on the content of a buffer containing reconstructed samples (processing block 302). After determining the waveform parameters, processing logic generates a set of predicted samples based on the set of waveform parameters (processing block 303).

With the predicted samples, processing logic subtracts the set of predicted samples from the input samples, resulting in a set of residual samples (processing block 304). Processing logic encodes the set of residual samples into a codeword and generates a set of reconstructed residual samples based on the codeword (processing block 305). Afterwards, processing logic adds the set of reconstructed residual samples to the set of predicted samples to form a set of reconstructed samples (processing block 306). Processing logic stores the set of reconstructed samples into the buffer (processing block 307).

Processing logic determines whether more input samples need to be coded (processing block 308). If there are more input samples to be coded, the process transitions to processing block 301 and the process is repeated for the next set of input samples. Otherwise, the encoding process terminates.

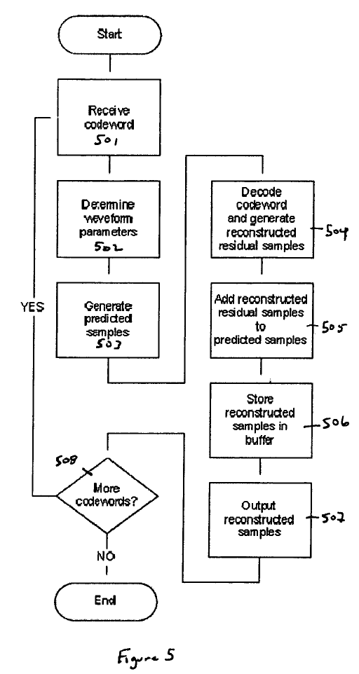

FIG. 4 is a block diagram of one embodiment of a decoder. Referring to FIG. 4, decoder 400 receives a codeword 401 and generates a set of output samples 403. In one embodiment, output samples 403 may represent a time sequence of one or more audio samples, for example, 10 samples of an audio signal sampled at 16 kHz. In one embodiment, codeword 401 is an ordered set of one or more bits.

Decoder 400 comprises a buffer 412 containing a number of previously decoded samples (e.g., previously generated output samples 403). In one embodiment, the size of buffer 412 is larger than the size of the set of input samples. For example, buffer 412 may contain 160 reconstructed samples. Initially, the value of the samples in buffer 412 may be set to a default value. For example, all values may be set to 0. In one embodiment, buffer 412 may operate in a first-in, first-out mode. That is, when a sample is inserted into buffer 412, a sample that has been in buffer 412 the longest amount of time is removed from buffer 412 in order to keep constant the number of samples in buffer 412.

Residual decoder 410 receives codeword 401 and outputs a set of reconstructed residual samples 402. In one embodiment, residual decoder 410 uses a dictionary of codevectors. Codeword 401 may represent the index of a selected codevector in the dictionary of codevectors. Reconstructed residual samples 402 are given by the selected codevector. In an alternate embodiment, residual decoder 410 may uses a lossless entropy decoder to generate reconstructed residual samples 402 from the codeword 401. For example, the lossless entropy encoder may use algorithms such as those described in “Lossless Coding Standards for Space Data Systems” by Robert F. Rice, 30ₜₕ Asilomar Conference on Signals, Systems and Computers, Vol. 1, pp. 577-585, 1996.

Decoder 200 further comprises adder 411 that adds reconstructed residual samples 402 received from residual decoder 410 and predicted samples 405 received from prediction generator 413 to form output samples 403. Output samples 403 are then stored in buffer 412.

Prediction generator 413 generates a set of predicted samples 405 from a set of analysis samples 404 stored in buffer 412. In one embodiment 413, prediction generator 413 comprises a waveform analyzer 421 and a waveform synthesizer 420. Waveform analyzer 421 receives analysis samples 404 from buffer 412 and generates a number of waveform parameters 406. In one embodiment, analysis samples 404 comprise all the samples stored in buffer 412. Waveform parameters 406 may include a set of amplitudes, phases and frequencies describing one or more waveforms. In one embodiment, waveform parameters 406 are derived such that the sum of waveforms described by waveform parameters 406 approximates analysis samples 404. An example process by which the waveform parameters 406 are computed is further described below. In one embodiment, waveform parameters 406 describe one or more sinusoids. Waveform synthesizer 420 receives waveform parameters 406 from waveform analyzer 421 and generates predicted samples 405 based on received waveform parameters 406.

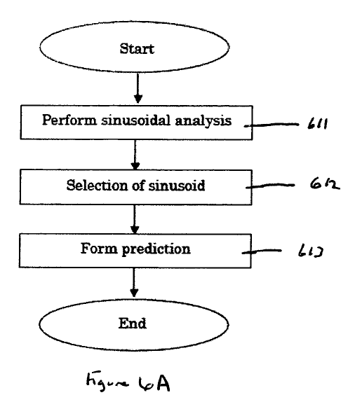

FIG. 5 is a flow diagram of one embodiment of a decoding process. The process is performed by processing logic that may comprise hardware (e.g., circuitry, dedicated logic, etc.), software (such as is run on a general purpose computer system or a dedicated machine), or a combination of both. The decoding process may be performed by a decoder such as the decoder 400 of FIG. 4.

Referring to FIG. 5, initially, processing logic received a codeword (processing block 501). Once the codeword is received, processing logic determines a set of waveform parameters based on the content of a buffer containing reconstructed samples (processing block 502).

Using the waveform parameters, processing logic generates a set of predicted samples based on the set of waveform parameters (processing block 503). Then, processing logic decodes the codeword and generates a set of reconstructed residual samples based on the codeword (processing block 504) and adds the set of reconstructed residual samples to the set of predicted samples to form a set of reconstructed samples (processing block 505). Processing logic stores the set of reconstructed samples in the buffer (processing block 506) and also outputs the reconstructed samples (processing block 507).

After outputting reconstructed samples, processing logic determines whether more codewords are available for decoding (processing block 508). If more codewords are available, the process transitions to processing block 501 where the process is repeated for the next codeword. Otherwise, the process ends.

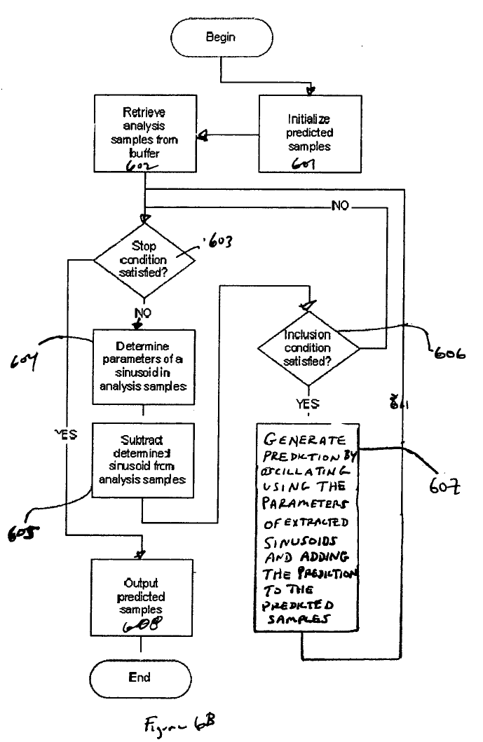

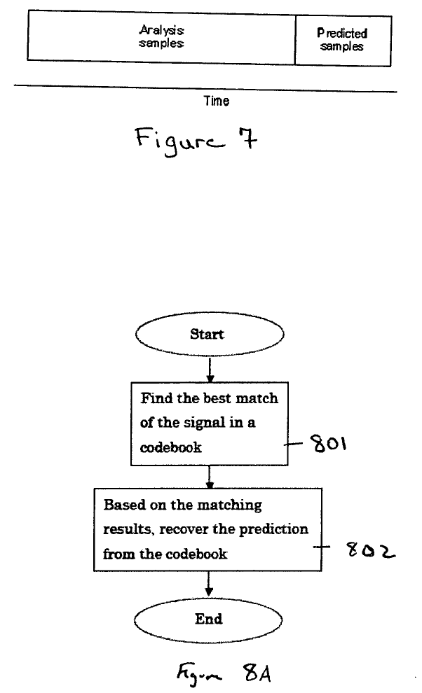

In one embodiment, the waveform matching prediction technique is sinusoidal prediction. FIG. 6A is a flow diagram of one embodiment of a process for sinusoidal prediction. The process is performed by processing logic that may comprise hardware (e.g., circuitry, dedicated logic, etc.), software (such as is run on a general purpose computer system or a dedicated machine), or a combination of both. The process may be performed by firmware.

Referring to FIG. 6A, the process begins by processing logic performing sinusoidal analysis (processing block 611). During analysis the relevant sinusoids of the signal s[n] within the analysis interval are determined. After performing sinusoidal analysis, processing logic selects a number of sinusoids (processing block 612). That is, processing logic locates a number of sinusoids with the corresponding amplitudes, frequencies, and phases, denoted herein respectively by aᵢ, wᵢ, and θᵢ, for i=1 to P, where P is the number of sinusoids. Using the selected sinusoid, processing logic forms a prediction (processing block 613). In one embodiment, the predicted signal is found using an oscillator where the selected sinusoids are included.

FIG. 6B is a flow diagram of one embodiment of a process for generating predicted samples from analysis samples using sinusoidal prediction. The process is performed by processing logic that may comprise hardware (e.g., circuitry, dedicated logic, etc.), software (such as is run on a general purpose computer system or a dedicated machine), or a combination of both. Such a process may be implemented in the prediction generator described in FIG. 2 and FIG. 4.

Referring to FIG. 6B, the process begins with the processing logic initializing a set of predicted samples (processing block 601). For example, all predicted samples are set to value zero. Then, processing logic retrieves a set of analysis samples from a buffer (processing block 602). Using the analysis samples, processing logic determines whether a stop condition is satisfied (processing block 603). In one embodiment, the stop condition is that the energy in the set of analysis samples is lower than a predetermined threshold. In an alternative embodiment, the stop condition is that the number of extracted sinusoids is larger than a predetermined threshold. In yet another embodiment, the stop condition is a combination of the above example stop conditions. Other stop conditions may be used.

If the stop condition is satisfied, processing transitions to processing block 608 where processing logic outputs predicted samples and the process ends. Otherwise, processing transitions to processing block 604 where processing logic determines parameters of a sinusoid from the set of analysis samples.

The parameters of the sinusoid may include an amplitude, a phase and a frequency. The parameters of the sinusoid may be chosen such as to reduce a difference between the sinusoid and the set of analysis samples. For example, the method described in “Speech Analysis/Synthesis and Modification Using an Analysis-by-Synthesis/Overlap-Add Sinusoidal Model” by E. George and M. Smith IEEE Transactions on Speech and Audio Processing, Vol. 5, No. 5, pp. 389-406, September 1997 may be used.

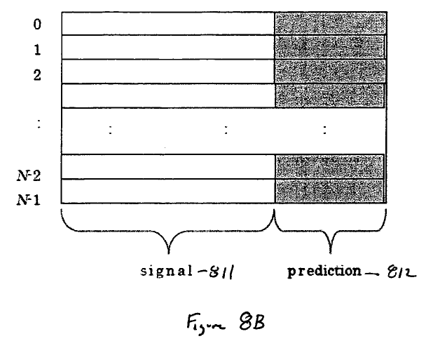

Afterwards, processing logic subtracts the determined sinusoid from the set of analysis samples (processing block 605), with the resultant samples used as analysis samples in the next iteration of the loop. Processing logic then determines whether the extracted sinusoid satisfies an inclusion condition (processing block 606). For example, the inclusion condition may be that the energy of the determined sinusoid is larger than a predetermined fraction of the energy in the set of analysis samples. If the inclusion condition is satisfied, processing logic generates a prediction by oscillating using the parameters of the extracted sinusoids and adding the prediction (that was based on the extracted sinusoid) to the predicted samples (processing block 607). FIG. 7 shows the time relationship between analysis samples and predicted samples. Then processing transitions to processing block 603.

Waveform Matching Prediction Generation

The prediction scheme described herein is based on waveform matching. The signal is analyzed in an analysis interval having Nₐ samples, and the results of the analysis are used for prediction within the synthesis interval of length equal to Nₛ. This is a forward prediction where the future is predicted from the past.

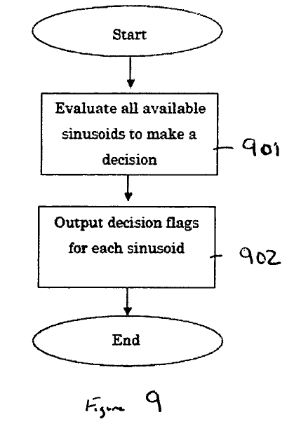

FIG. 8A is a flow diagram of one embodiment of a prediction process based on waveform matching. The process is performed by processing logic that may comprise hardware (e.g., circuitry, dedicated logic, etc.), software (such as is run on a general purpose computer system or a dedicated machine), or a combination of both. The process may be performed by firmware.

Referring to FIG. 8A, the process begins by processing logic finding the best match of the input signal samples against those stored in a data structure (processing block 801). Based on the matching results, processing logic recovers a prediction from the data structure (processing block 802).

In one embodiment, the data structure comprises a codebook. In such a case, the samples within the codebook (or codevector) that best matches the input signal samples are selected. In one embodiment, the prediction is then obtained directly from the codebook, where each codevector is associated with a group of samples dedicated to the purpose of prediction.

One embodiment of the structure of the codebook is shown in FIG. 8B. The codebook structure of FIG. 8B is based on waveform matching and has a total of N codevectors available. Referring to FIG. 8B, a number of codevectors containing the signal 811 and the associated prediction 812 are assigned certain indices, from 0 to N−1 with N being the size of the codebook, or the total number of codevectors. Using this codebook, an input signal vector is matched against each signal codevector, the signal codevector that is the closest to the input signal vector is located, and then the prediction is directly recovered from the codebook.

An Embodiment for Sinusoidal Prediction

In the following discussion, it is assumed that for a certain frame (or a block of samples), the analysis interval corresponds to nε[0, Nₐ−1], and the synthesis interval corresponds to nε[Nₐ, Nₐ+Nₛ−1]. The sinusoidal analysis procedure is performed in the analysis interval where the frequencies (wᵢ), amplitudes (aᵢ), and phases (θᵢ) for i=1 to P are determined. In order to perform sinusoidal analysis, in one embodiment, the analysis-by-synthesis (AbS) procedure is an iterative method where the sinusoids are extracted from the input signal in a sequential manner. After extracting one sinusoid, the sinusoid itself is subtracted from the input signal, forming in this way a residual signal; the residual signal then becomes the input signal for analysis in the next step, where another sinusoid is extracted. This process is performed through a search procedure in which a set of candidate frequencies is evaluated with the highest energy sinusoids being extracted. In one embodiment, the candidate frequencies are obtained by sampling the interval [0, π] uniformly, given by

$$w [ m ] = \frac{m \cdot π}{{N}_{w} - 1} ; m = 0 to {N}_{w} - 1 \qquad ( 1.1 )$$

where N_{w} is the number of candidate frequencies, its value is a tradeoff between quality and complexity. Note that the number of sinusoids P is a function of the signal and is determined based on the energy of the reconstructed signal, denoted by Eᵣ(P). That is, during the execution of the AbS procedure, P starts from zero and increases by one after extracting one sinusoid, when the condition
Eᵣ(P)/Eₛ>QUIT_{—}RATIO (1.2)
is reached the procedure is terminated; otherwise, it continues to extract more sinusoids until that condition is met. In equation (1.2), Eₛ is the energy of the original input signal and QUIT_RATIO is a constant, with a typical value of 0.95.

The reconstructed signal inside the analysis interval is

$${s}_{r} [ n ] = {{\sum }_{i - 1}}^{P} {a}_{i} cos ( {w}_{i} n + {θ}_{i} ) ; n = 0 to {N}_{a} - 1 \qquad ( 1.3 )$$

each sinusoid has an energy given by

$${E}_{i} = {\sum }_{n = 0}^{{N}_{a} - 1} ( {a}_{i} cos ( {w}_{i} n + {θ}_{i} ) ) ; i = 1 to P . \qquad ( 1.4 )$$

Then the prediction is formed with

$$\hat{s} [ n ] = {\sum }_{i = 1}^{P} {p}_{i} {a}_{i} cos ( {w}_{i} n + {θ}_{i} ) ; n = {N}_{a} to {N}_{a} + {N}_{s} - 1. \qquad ( 1.5 )$$

with pᵢ, i=1 to P the decision flags associated with the ith sinusoid. The flag is equal to 0 or 1 and its purpose is to select or deselect the ith sinusoid for prediction.

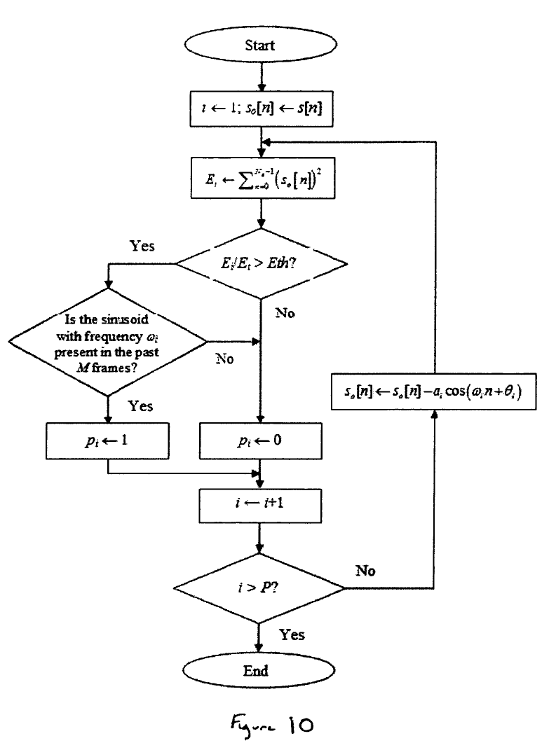

Thus, once the analysis procedure is completed, it is necessary to evaluate the extracted sinusoids to decide which one would be included for actual prediction. FIG. 9 is a flow diagram of one embodiment of a process for selecting a sinusoid for use in prediction. The process is performed by processing logic that may comprise hardware (e.g., circuitry, dedicated logic, etc.), software (such as is run on a general purpose computer system or a dedicated machine), or a combination of both. The process may be performed by firmware.

Referring to FIG. 9, the process begins by processing logic evaluating all available sinusoids to make a decision (processing block 901). After evaluation, processing logic outputs decision flags for each sinusoid (processing block 902). In other words, based on certain set of conditions, a decision is made regarding the adoption of a particular sinusoid for prediction. The decisions are summarized in a number of flags (denoted as p in equation (1.5)). In one embodiment, the criterion upon which a decision is made is largely dependent on the past history of the signal, since only steady sinusoids should be adopted for prediction.

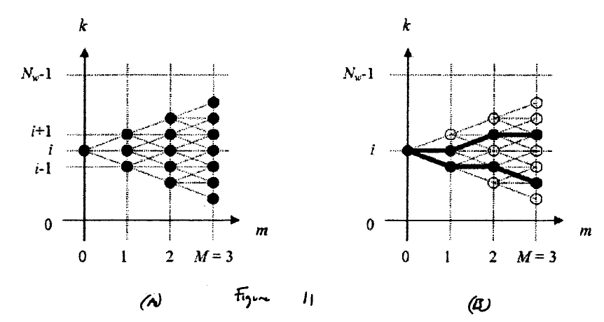

FIG. 10 is a flow diagram of one embodiment of a process for making a decision as to the selection of a particular sinusoid. The process is performed by processing logic that may comprise hardware (e.g., circuitry, dedicated logic, etc.), software (such as is run on a general purpose computer system or a dedicated machine), or a combination of both. The process may be performed by firmware.

Referring to FIG. 10, the inputs to the process are the parameters of the extracted sinusoids (P, Eᵢ, wᵢ, aᵢ, \overline{⊂}ᵢ) with the output being the sequence pᵢ. As shown in FIG. 10, there are two criteria that a sinusoid must meet in order to be included to perform prediction. First, its energy ratio Eᵢ/Eₜ must be above a threshold Eth. This is because a steady sinusoid normally should have a strong presence within the frame in terms of energy ratio; a noise signal, for instance, tends to have a flat or smooth spectrum, with the energy distributed almost evenly for all frequency components. Second, the sinusoid must be present for a number of consecutive frames (M). This is to ensure to select those components that are steady to perform prediction, since a steady component tends to repeat itself in the near future. Once a given sinusoid is examined, it is removed from sₒ and the process repeats until all sinusoids are exhausted.

In one embodiment, in order to determine whether a component of frequency wᵢ has been present in the past M frames, a small neighborhood near the intended frequency is checked. For example, the i−1, i, and i+1 components of the past frame may be examined in order to make a decision to use the sinusoid. In alternative embodiments, this can be extended toward the past containing the data of M frames (e.g., 2-3 frames).

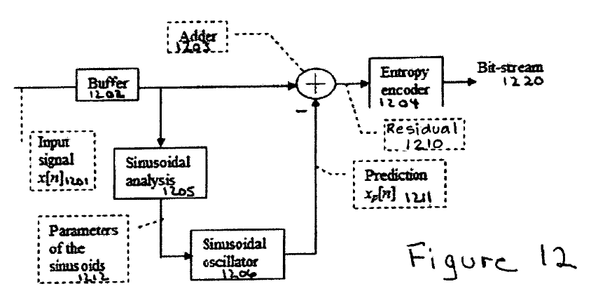

FIG. 11 shows each frequency component of a frame being associated with three components from the past frame. In such a case, there are a total of 3^{M} sets of points in the {k, m} plane that need to be examined. If for any of the 3^{M} sets, all associated sinusoids are present, then the corresponding sinusoid at m=0 is included for prediction, since it implies that the current sinusoid is likely to have been evolved from other sinusoids from the past.

The following C code implements a recursive algorithm to verify the time/frequency points, with the result used to decide whether a certain sinusoid should be adopted for prediction.

{

bool result = false;
int i;
if (level == M−1)

result = getPreviousStatus(frequencyIndex, M−1);

else

for (i = frequencyIndex−1; i <= frequencyIndex+1; i++)

if (f[i] [level+1])

result | = confirm(i, level+1);

return result;

}
bool getPreviousStatus(int frequencyIndex, int level)
{

bool result = f[frequencyIndex] [level+1];
if (frequencyIndex+1 < Nw)

result | = f [frequencyIndex+1] [level+1];

if (frequencyIndex−1 >= 0)

result |= f[frequencyIndex−1][level+1];

return result;

}

In the previous code, M is the length of the history buffer and f[k][m] is the history buffer, where each element is either 0 or 1, and is used to keep track of the sinusoidal components present in the past. The value off is determined with

$$f [ k ] [ 0 ] = \{ \begin{matrix}1 ; & if w [ k ] = {w}_{i} , i = 1 , … , P \\ 0 ; & otherwise\end{matrix} \qquad ( 1.6 )$$

where w[k], k=0 to N_{w}−1 are the N_{w} candidate frequencies in equation (1.1). The array is shifted in the next frame in the sense that
f[k][m]<←f[k][m−1]; m=M,M−1, . . . ,1 (1.7)
Thus, the results for a total of M past frames are stored in the array, which are used to decide whether a certain frequency component has been present for a long enough period of time. Note that m=0 corresponds to the current frame in equation (1.7).
Additional Coding Embodiments

FIG. 12 is a block diagram of one embodiment of a lossless audio encoder that uses sinusoidal prediction. Referring to FIG. 12, the input signal x 1201 is stored in buffer 1202. The purpose of buffer 1202 is to group a number of samples together for processing purposes so that by processing several samples at once, a higher coding efficiency can normally be achieved.

A predicted signal 1211 is generated using sinusoidal analysis 1205 and sinusoidal oscillator 1206. Sinusoidal analysis processing 1205 receives previously received samples of input signal 1201 from buffer 1202 and generates parameters of the sinusoids 1212. In one embodiment, sinusoidal analysis processing 1205 extracts the amplitudes, frequencies, and phases of a number of sinusoids to generate sinusoid parameters 1212. Using sinusoid parameters 1212, sinusoidal oscillator 1206 generates a prediction in the form of prediction signal 1211.

The predicted signal xp 1211 is subtracted from input signal 1201 using adder (subtractor) 1203 to generate a residual signal 1210. Entropy encoder 1204 receives and encodes residual signal 1210 to produce bit-stream 1220. Entropy encoder 1204 may comprises any lossless entropy encoder known in the art. Bit-stream 1220 is output from the encoder and may be stored or sent to another location.

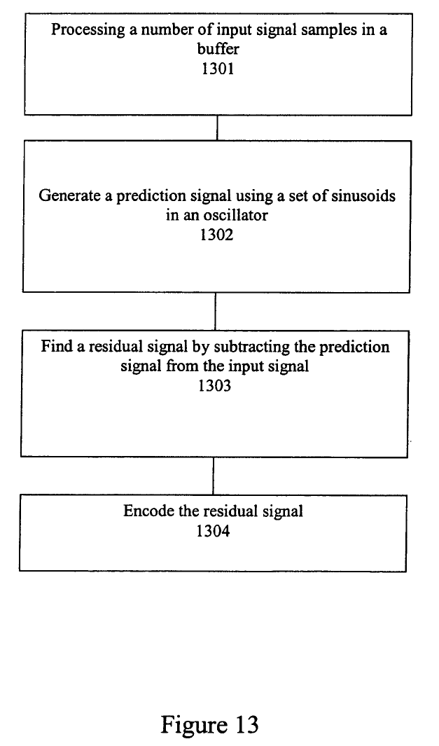

FIG. 13 is a flow diagram of one embodiment of the encoding process. The encoding process is performed by processing logic that may comprise hardware (e.g., circuitry, dedicated logic, etc.), software (such as is run on a general purpose computer system or a dedicated machine), or a combination of both. The processing may be performed with firmware. The encoding process may be performed by the components of the encoder of FIG. 12.

Referring to FIG. 13, the process begins by processing logic a number of input signal samples in a buffer (processing block 1301). Processing logic also generates a prediction signal using a set of sinusoids in an oscillator (processing block 1302). Next, processing logic finds a residual signal by subtracting the prediction signal from the input signal (processing block 1303) and encodes the residual signal (processing block 1304). Thereafter, the encoding process continues until no additional input samples are available.

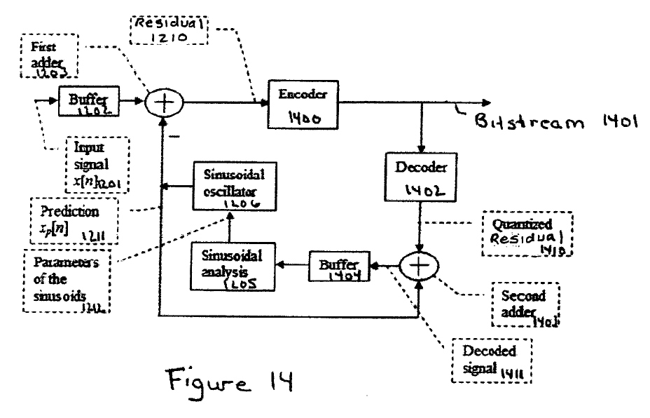

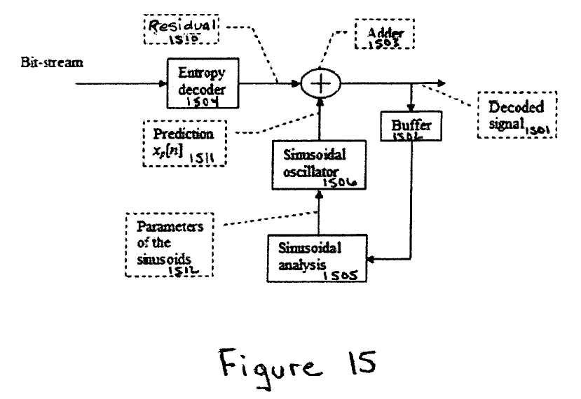

FIG. 14 is a block diagram of one embodiment of a lossy audio encoder that uses sinusoidal prediction. Referring to FIG. 14, the input signal x[n] 1201 is stored in buffer 1202. The purpose of buffer 1202 is to group a number of samples together for processing purposes so that by processing several samples at once, a higher coding efficiency can normally be achieved.

A predicted signal 1211 is generated using sinusoidal analysis 1205 and sinusoidal oscillator 1206. Sinusoidal analysis processing 1205 receives previously received samples of input signal 1201 from buffer 1202 and generates parameters of the sinusoids 1212. In one embodiment, sinusoidal analysis processing 1205 extracts the amplitudes, frequencies, and phases of a number of sinusoids to generate sinusoid parameters 1212. Using sinusoid parameters 1212, sinusoidal oscillator 1206 generates a prediction in the form of prediction signal 1211.

The predicted signal xₚ 1211 is subtracted from input signal 1201 using adder (subtractor) 1203 to generate a residual signal 1210. Encoder 1400 receives and encodes residual signal 1210 to produce bit-stream 1401. Encoder 1400 may comprise any lossy coder known in the art. Bit-stream 1401 is output from the encoder and may be stored or sent to another location.

Decoder 1402 also receives and decodes bit-stream 1401 to produce a quantized residual signal 1410. Adder 1403 adds quantized residual signal 1420 to predicted signal 1211 to produce decoded signal 1411. Buffer 1404 buffers decoded signal 1411 to group a number of samples together for processing purposes. Buffer 1404 provides these samples to sinusoidal analysis 1205 for use in generating future predictions.

FIG. 15 is a block diagram of one embodiment of a lossless audio decoder. Referring to FIG. 15, entropy decoder 1504 receives bit-stream 1520 and decodes bit-stream 1520 into residual signal 1510. Adder 1503 adds residual signal 1510 to prediction signal xₚ[n] 1511 to produce decoded signal 1501. Bluffer 1502 stores decoded signal 1501 as well. The purpose of buffer 1502 is to group a number of samples together for processing purposes so that by processing several samples at once, a higher coding efficiency can normally be achieved.

Prediction signal 1511 is generated using sinusoidal analysis 1505 and sinusoidal oscillator 1506. Sinusoidal analysis processing 1505 receives previously generated samples of decoded signal 1501 from buffer 1502 and generates parameters of the sinusoids 1512. In one embodiment, sinusoidal analysis processing 1505 extracts the amplitudes, frequencies, and phases of a number of sinusoids to generate sinusoid parameters 1512. Using sinusoid parameters 1512, sinusoidal oscillator 1506 generates a prediction in the form of prediction signal 1511. Thus, the decoded signal is used to identify the parameters of the predictor.

The described system is backward adaptive because the parameters of the predictor and the prediction are based on the decoded signal, hence no explicit transmission of the parameters of the predictor is necessary.

Note that the decoder of FIG. 15 may be modified to be a lossy audio decoder by modifying entropy decoder 1504 to be a lossy decoder. In such a case, residual signal 1510 is a quantized residual signal.

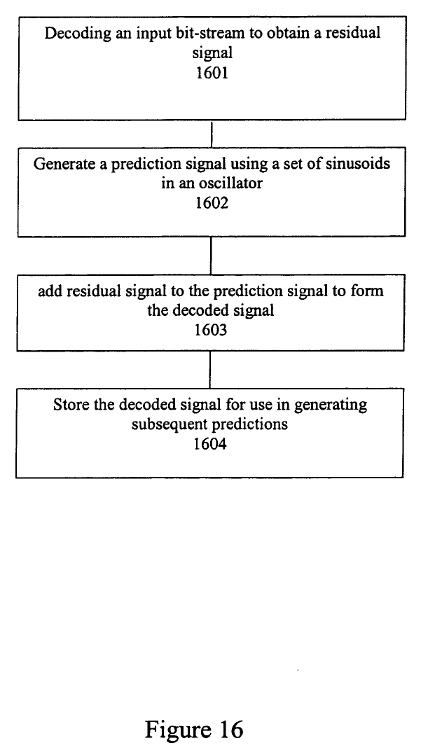

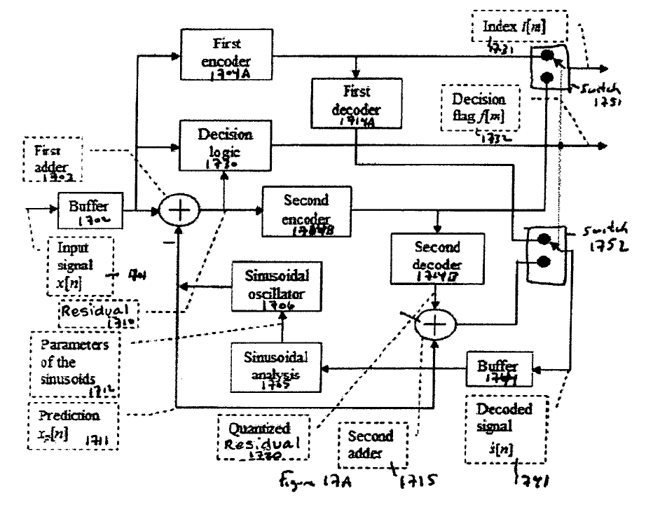

FIG. 16 is a flow diagram of one embodiment of the decoding process. The decoding process is performed by processing logic that may comprise hardware (e.g., circuitry, dedicated logic, etc.), software (such as is run on a general purpose computer system or a dedicated machine), or a combination of both. This includes firmware. The decoding process may be performed by the components of the decoder of FIG. 15.

Referring to FIG. 16, the process begins by processing logic decoding an input bit-stream to obtain a residual signal (processing block 1601). Processing logic also generates a prediction signal using a set of sinusoids in an oscillator (processing block 1602). Next, processing logic adds residual signal to the prediction signal to form the decoded signal (processing block 1603). Processing logic stores the decoded signal for use in generating subsequent predictions (processing block 1604). Thereafter, the decoding process continues until no additional input samples are available.

Embodiments with Switched Quantizers

In one embodiment, coders described above are extended to include two quantizers that are selected based on the condition of the input signal. An advantage of this extension is that it enables selection of one of two quantizers depending on the performance of the predictor. If the predictor is performing well, the encoder quantizes the residual; otherwise, the encoder quantizes the input signal directly. The bit-stream of this coder has two components: index to one of the quantizer and a 1-bit decision flag indicating the selected quantizer.

One mechanism in which the quantizer is selected is based on the prediction gain, defined by

$$PG = 10 log ( \frac{{\sum }_{n} {x}^{2} [ n ]}{{\sum }_{n} {ⅇ}^{2} [ n ]} ) = 10 log ( \frac{{\sum }_{n} {x}^{2} [ n ]}{{\sum }_{n} {( x [ n ] - {x}_{p} [ n ] )}^{2}} ) \qquad ( 1.8 )$$

with x the input signal, xₚ the predicted signal, and e the residual. The summations are performed within the synthesis interval. Thus, if the performance of the predictor is good (for instance, PG>0), then the encoder quantizes the residual signal; otherwise, the encoder quantizes the input signal directly.

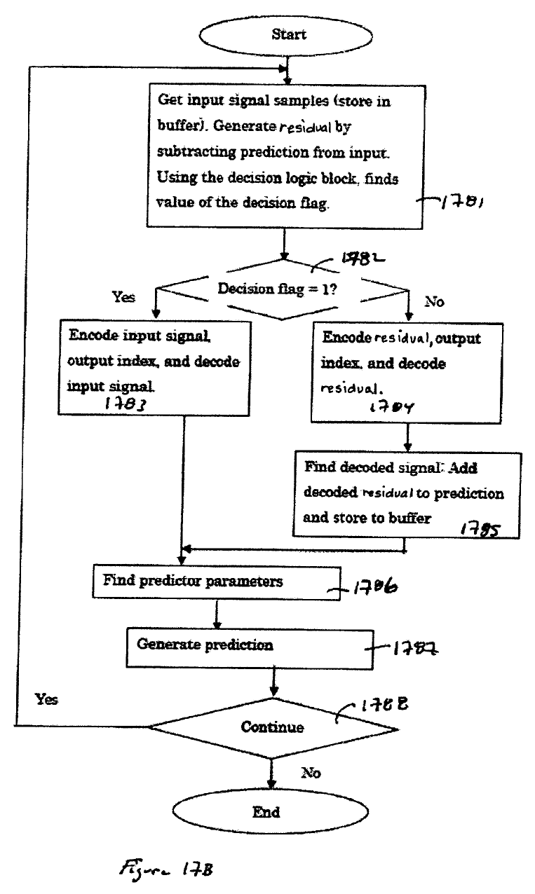

FIG. 17A is a block diagram of one embodiment of an audio encoder that includes switched quantizers and sinusoidal prediction. Referring to FIG. 17A, the input signal x[n] 1701 is stored in buffer 1702. The purpose of buffer 1702 is to group a number of samples together for processing purposes so that by processing several samples at once, a higher coding efficiency can normally be achieved.

A predicted signal 1711 is generated using sinusoidal analysis 1705 and sinusoidal oscillator 1706. Sinusoidal analysis processing 1705 receives previously received samples of decoded signal 1741 from buffer 1744 and generates parameters of the sinusoids 1712. In one embodiment, sinusoidal analysis processing 1705 extracts the amplitudes, frequencies, and phases of a number of sinusoids to generate sinusoid parameters 1712. Using sinusoid parameters 1712, sinusoidal oscillator 1706 generates a prediction in the form of prediction signal 1711.

The predicted signal xₚ 1711 is subtracted from input signal 1701 using adder (subtractor) 1703 to generate a residual signal 1710. Residual signal 1710 is sent to decision logic 1730 and encoder 1704B.

Encoder 1704B receives and encodes residual signal 1710 to produce an index 1735 that may be selected for output using switch 1751.

Decoder 1714B also receives and decodes the output of encoder 1704B to produce a quantized residual signal 1720. Adder 1715 adds quantized residual signal 1720 to predicted signal 1711 to produce a decoded signal that is sent to switch 1752 for possible selection as an input into buffer 1744. Buffer 1744 buffers decoded signals to group a number of samples together for processing purposes so that several samples may be processed at once. Buffer 1744 provides these samples to sinusoidal analysis 1705 for use in generating future predictions.

Encoder 1704A also receives samples of the input signal from buffer 1702 and encodes them. The encoded output is sent to an input of switch 1751 for possible selection as the index output from the encoder. The encoded output is also sent to decoder 1714B for decoding. The decoded output of decoder 1714B added to the predicted signal 1711 is sent to switch 1752 for possible selection as an input into buffer 1744.

Decision logic 1730 receives the samples of the input signal from buffer 1702 along with the residual signal 1710 and determines whether to select the output of encoder 1704A or 1704B as the index output of the encoder. This determination is made as described herein and is output from decision logic as decision flag 1732.

Switch 1751 is controlled via decision logic 1730 to output an index from either encoder 1704A or 1704B, while switch 1752 is controlled via decision logic 1730 to enable selection of the output of decoder 1714A or adder 1715 to be input into buffer 1744.

FIG. 17B is a flow diagram of one embodiment of an encoding process using switched quantizers. The process is performed by processing logic that may comprise hardware (e.g., circuitry, dedicated logic, etc.), software (such as is run on a general purpose computer system or a dedicated machine), or a combination of both. The process may be performed by the encoder of FIG. 17A.

Referring to FIG. 17B, the process begins by gathering a number of input signal samples in the buffer, generating a residual signal by subtracting the prediction signal from the input signal, and, depending on the performance of the predictor as measured by the energy of the input signal and the energy of the residual, using a decision logic block to decide which signal is being quantized: input signal or residual (processing block 1781). Processing logic also determines the value of the decision flag in processing block 1781, which is transmitted as part of the bit-stream.

Processing logic then determines if the decision flag is set to 1 (processing block 1782). If the decision logic block decides to quantize the input signal, processing logic quantizes the input signal with the index transmitted as part of the bit-stream (processing block 1783); otherwise, processing logic quantizes the residual signal with the index transmitted as part of the bit-stream (processing block 1784). Then processing logic obtains the decoded signal by adding the decoded residual signal to the prediction signal (processing block 1785). The result is stored in a buffer.

Using the decoded signal, processing logic determines the parameters of the predictor (processing block 1786). Using the parameters, processing logic generates the prediction signal using the predictor together with the decoded signal (processing block 1787). The encoding process continues until no additional input samples are available.

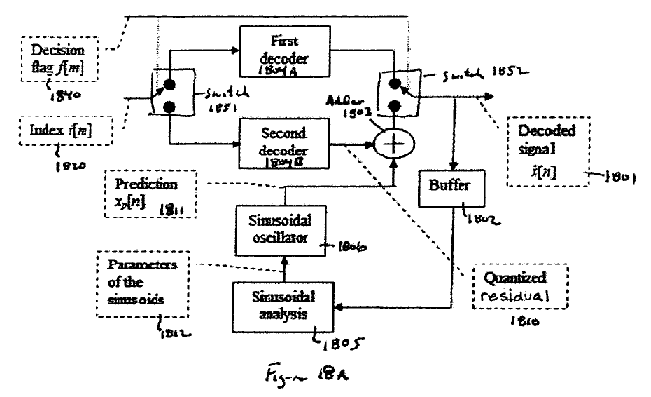

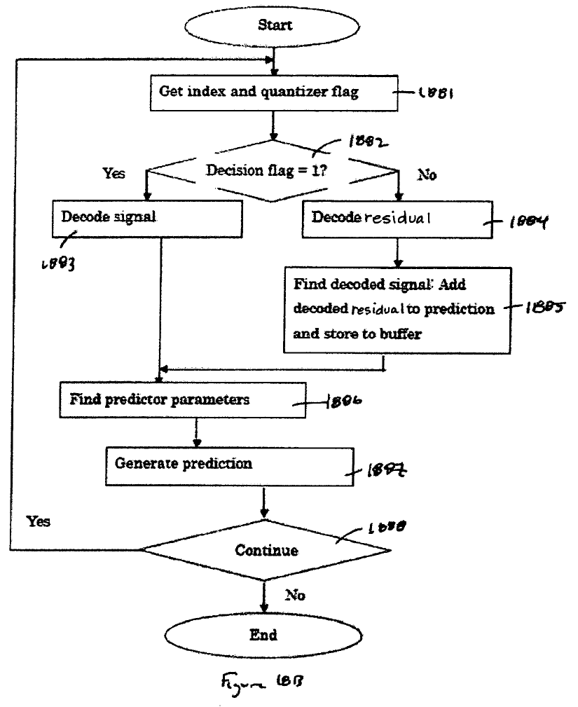

FIG. 18A is a block diagram of one embodiment of an audio decoder that uses switched quantizers. Referring to FIG. 18A, an input signal in the form of index 1820 is input into switch 1851. Switch 1851 is responsive to decision flag 1840 received with index 1820 as inputs to the decoder. Based on decision flag 1840, switch 1851 causes the index to be sent to either of decoders 1804A and 1804B. The output of decoder 1804A is input to switch 1852, while the output of decoder 1804B is the quantized residual signal 1810 and is input to adder 1803. Adder 1803 adds quantized residual signal 1810 to prediction signal 1811. The output of adder 1803 is input to switch 1852.

Switch 1852 selects the output of decoder 1804A or the output of adder 1803 as the decoded signal 1801 as the output of the decoder based on decision flag 1840.

Buffer 1802 stores decoded signal 1801 as well. Buffer 1802 groups a number of samples together for processing purposes so that several samples may be processed at once.

Prediction signal 1811 is generated using sinusoidal analysis 1805 and sinusoidal oscillator 1806. Sinusoidal analysis processing 1805 receives previously generated samples of decoded signal 1801 from buffer 1802 and generates parameters of the sinusoids 1812. In one embodiment, sinusoidal analysis processing 1805 extracts the amplitudes, frequencies, and phases of a number of sinusoids to generate sinusoid parameters 1812. Using sinusoid parameters 1812, sinusoidal oscillator 1806 generates a prediction in the form of prediction signal 1811. Thus, the decoded signal is used to identify the parameters of the predictor.

FIG. 18B is a flow diagram of one embodiment of a process for decoding a signal using switched quantizers. The process is performed by processing block that may comprise hardware (e.g., circuitry, dedicated logic, etc.), software (such as is run on a general purpose computer system or a dedicated machine), or a combination of both. The process may be performed by the decoder of FIG. 18A.

The process begins by processing logic recovering an index and a decision flag from the bit-stream (processing block 1881). Depending on the value of the decision flag, processing logic either decodes the index to obtain the decoded signal (processing block 1883), or decodes the residual signal (processing block 1884). In the latter case, processing logic finds the decoded signal by adding the decoded residual signal to the prediction signal.

Using the decoded signal, processing logic then determines the parameters of the sinusoids (processing block 1886). Using the parameters, processing logic generates the prediction signal using the parameters of the sinusoids together with the decoded signal (processing block 1887).

The decoding process continues until no additional data from the bit-stream are available.

An Embodiment with Signal Switching for Lossless Coding

In alternative embodiments, the encoding and decoding mechanisms are disclosed, which include a signal switching mechanism. In this case, the coding goes through the sinusoidal analysis process where the amplitudes, frequencies, and phases of a number of sinusoids are extracted and then used by the sinusoidal oscillator to generate the prediction.

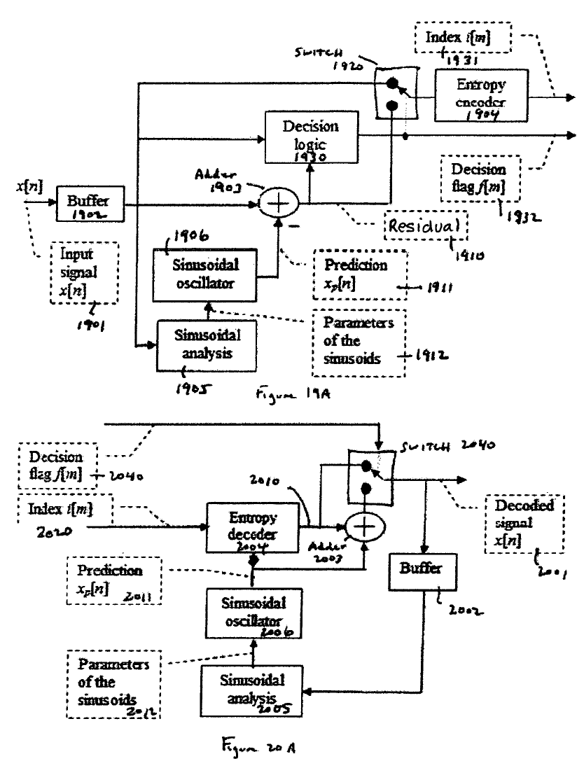

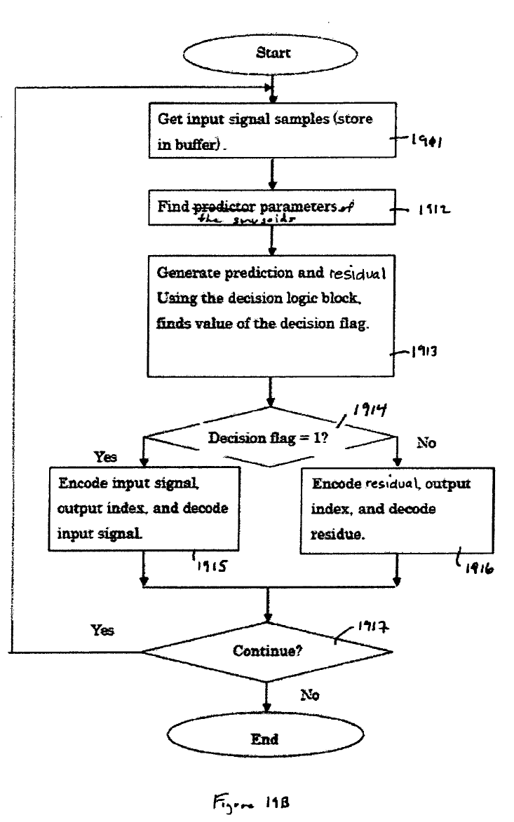

FIG. 19A is a block diagram of one embodiment of an audio encoder that includes signal switching and sinusoidal prediction. Referring to FIG. 19A, the input signal x[n] 1901 is stored in buffer 1902. Buffer 1902 groups a number of samples together for processing purposes to enable processing several samples at once. Buffer 1902 also outputs samples of input signal 1901 to an input of switch 1920.

A predicted signal 1911 is generated using sinusoidal analysis processing 1905 and sinusoidal oscillator 1906. Sinusoidal analysis processing 1905 receives buffered samples of input signal 1901 from buffer 1902 and generates parameters of the sinusoids 1912. In one embodiment, sinusoidal analysis processing 1905 extracts the amplitudes, frequencies, and phases of a number of sinusoids to generate sinusoid parameters 1912. Using sinusoid parameters 1912, sinusoidal oscillator 1906 generates a prediction in the form of prediction signal 1911.

The predicted signal xₚ 1911 is subtracted from input signal 1901 using adder (subtractor) 1903 to generate a residual signal 1910. Residual signal 1910 is sent to decision logic 1930 and switch 1920.

Decision logic 1930 receives the samples of the input signal from buffer 1902 along with the residual signal 1910 and determines whether to select the input signal samples stored in buffer 1902 or the residual signal 1910 to be encoded by the entropy encoder 1904. This determination is made as described herein and is output from decision logic as decision flag 1932. Flag 1932 is sent as part of the bit-stream and controls the position of switch 1920.

Encoder 1904 receives and encodes the output of switch 1920 to produce an index 1931.

FIG. 19B is a flow diagram of one embodiment of an encoding process. The decoding process is performed by processing logic that may comprise hardware (e.g., circuitry, dedicated logic, etc.), software (such as is run on a general purpose computer system or a dedicated machine), or a combination of both. This includes firmware. The encoding process may be performed by the components of the encoder of FIG. 19A.

Referring to FIG. 19B, the process begins by processing logic obtaining a number of input signal samples in a buffer (processing block 1911). Using the input samples, processing logic finds parameters of the sinusoids (processing block 1912). Processing logic then generates a prediction signal using the set of sinusoids in an oscillator together with the input signal (processing block 1913). Also in processing block 1913, processing logic finds the residual signal by subtracting the prediction signal from the input signal. Depending on the performance of the predictor as measured by the energy of the input signal and the energy of the residual signal, processing logic determines whether the decision flag is set to 1 (processing block 1914) to determine which signal is being encoded: the input signal or the residual signal. The value of the decision flag is sent as part of the bit-stream. If the decision logic block decides to encode the input signal, the input signal is encoded with the resultant index transmitted as part of the bit-stream (processing block 1915); otherwise, the residual signal is encoded with the index transmitted as part of the bit-stream (processing block 1916). Thereafter, the encoding process continues until no additional input samples are available.

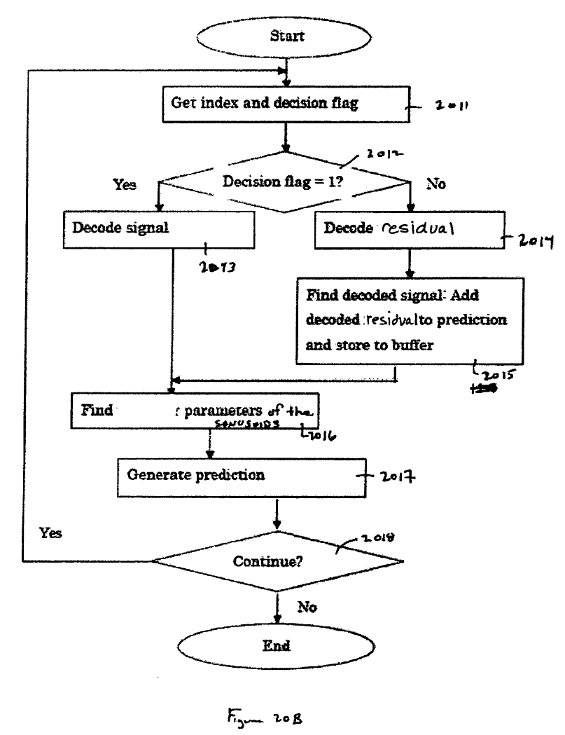

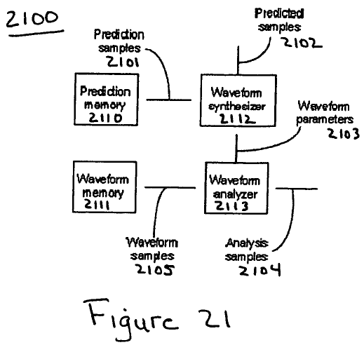

FIG. 20A is a block diagram of one embodiment of an audio lossless decoder that uses signal switching and sinusoidal prediction. Referring to FIG. 20A, an input signal in the form of index 2020 is input into entropy decoder 2004. The output of decoder 2004 is input to switch 2040.

Adder 2003 adds the output of the entropy decoder 2010 to prediction signal 2011. Prediction signal 2011 is generated using sinusoidal analysis 2005 and sinusoidal oscillator 2006. Sinusoidal analysis processing 2005 receives previously generated samples of decoded signal 2001 from buffer 2002 and generates parameters of the sinusoids 2012. In one embodiment, sinusoidal analysis processing 2005 extracts the amplitudes, frequencies, and phases of a number of sinusoids to generate sinusoid parameters 2012. Using sinusoid parameters 2012, sinusoidal oscillator 2006 generates a prediction in the form of prediction signal 2011. Thus, the decoded signal is used to identify the parameters of the predictor. The output of adder 2003 is input to switch 2040.

Switch 2040 selects the output of decoder 2004 or the output of adder 2003 as the decoded signal 2001. The selection is based on the value of decision flag 2040 recovered from the bit-stream.

Buffer 2002 stores decoded signal 2001 as well. Buffer 2002 groups a number of samples together for processing purposes so that several samples may be processed at once. The output of buffer 2002 is sent to an input of sinusoidal analysis 2005.

FIG. 20B is a flow diagram of one embodiment of a process for decoding a signal using signal switching and sinusoidal prediction. The process is performed by processing logic that may comprise hardware (e.g., circuitry, dedicated logic, etc.), software (such as is run on a general purpose computer system or a dedicated machine), or a combination of both. The process may be performed by the decoder of FIG. 20A.

The process begins by processing logic recovering an index and a decision flag from the bit-stream (processing block 2011). Depending on the value of the decision flag (processing block 2012), processing logic recovers either the decoded signal (processing block 2013) or the residual signal (processing block 2014). In the latter case, processing logic finds the decoded signal by adding the decoded residual signal to the prediction signal (processing block 2015).

Using the decoded signal, processing logic then determines the parameters of the sinusoids (processing block 2016) and, using the parameters, generates the prediction signal using the predictor together with the decoded signal (processing block 2017).

The decoding process continues until no additional data from the bit-stream are available.

Matching Pursuit Prediction

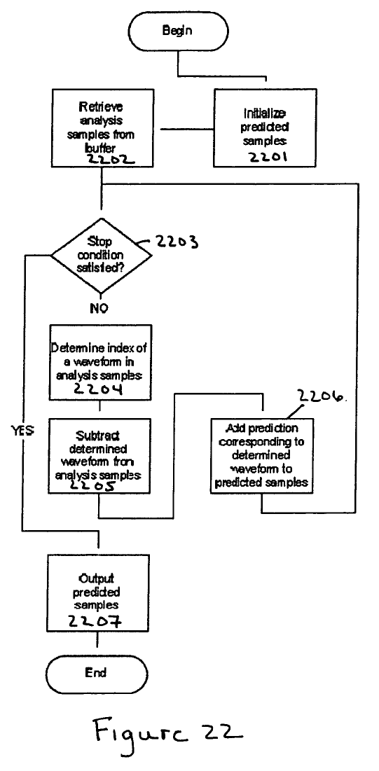

In one embodiment, the prediction performed is matching pursuant prediction. FIG. 21 is a block diagram of an alternate embodiment of a prediction generator that generates a set of predicted samples from a set of analysis samples using matching pursuit. Referring to FIG. 21, prediction generator 2100 comprises a waveform analyzer 2113, a waveform memory 2111, a waveform synthesizer 2112, and a prediction memory 2110. Waveform memory 2111 contains one or more sets of waveform samples 2105. In one embodiment, the size of each set of waveform samples 2105 is equal to the size of the set of analysis samples 2104. Waveform analyzer 2113 is connected to waveform memory 2111. Waveform analyzer 2113 receives analysis samples 2104 and matches analysis samples 2104 with one or more set of waveform samples 2105 stored in waveform memory 2111. The output of waveform analyzer 2113 is one or more waveform parameters 2103. In one embodiment, waveform parameter 2103 comprises one or more indices corresponding to the one or more matched set of waveform samples.

Prediction memory 2110 contains one or more sets of prediction samples 2101. In one embodiment, the size of each set of prediction samples 2101 is equal to the size of the set of predicted samples 2102. In one embodiment, the number of sets in prediction memory 2110 is equal to the number of sets in waveform memory 2111, and there is a one-to-one correspondence between sets in waveform memory 2111 and sets in prediction memory 2110.

Waveform synthesizer 2112 receives one or more of waveform parameters 2103 from waveform analyzer 2113, and retrieves the sets of prediction samples 2101 from prediction memory 2110 corresponding to the one or more indices comprised the waveform parameters 2103. The sets of prediction samples 2101 are then summed to form predicted samples 2102. The waveform synthesizer 2112 outputs the set of predicted samples.

In an alternate embodiment, waveform parameters 2103 may further comprise a weight for each index. Waveform synthesizer 2112 then generates predicted samples 2102 by a weighted sum of prediction samples 2101.

FIG. 22 is a flow diagram describing the process for generating predicted samples from analysis samples using matching pursuit. The process is performed by processing logic that may comprise hardware (e.g., circuitry, dedicated logic, etc.), software (such as is run on a general purpose computer system or a dedicated machine), or a combination of both. In one embodiment, the processing logic is part of the precompensator. Such a process may be implemented in the prediction generator described in FIG. 21.

Referring to FIG. 22, at first, processing logic initializes a set of predicted samples (processing block 2201). For example, in one embodiment, all predicted samples are set to value zero.

Next, processing logic retrieves a set of analysis samples from a buffer (processing block 2202). Using the analysis samples, processing logic determines whether a stop condition is satisfied (processing block 2203). In one embodiment, the stop condition is that the energy in the set of analysis samples is lower than a predetermined threshold. In an alternative embodiment, the stop is that a number of extracted sinusoids is larger than a predetermined threshold. In yet another alternative embodiment, the stop condition is a combination of the above examples.

However, other conditions may be used. If the stop condition is satisfied, processing transitions to processing block 2207. Otherwise, processing proceeds to processing block 2204 where processing logic determines an index of a waveform from the set of analysis samples. The index points to a waveform stored in a waveform memory. In one embodiment, the index is determined by finding a waveform in a waveform memory that matches the set of analysis samples best.

With the index, processing logic subtracts the waveform associated with the determined index from the set of analysis samples (processing block 2205). Then processing logic adds the prediction associated with the determined index to the set of predicted samples (processing block 2206). The prediction is retrieved from a prediction memory. After completing the addition, processing transitions to processing block 2203 to repeat the portion of the process. At processing block 2207, processing logic outputs the predicted samples and the process ends.

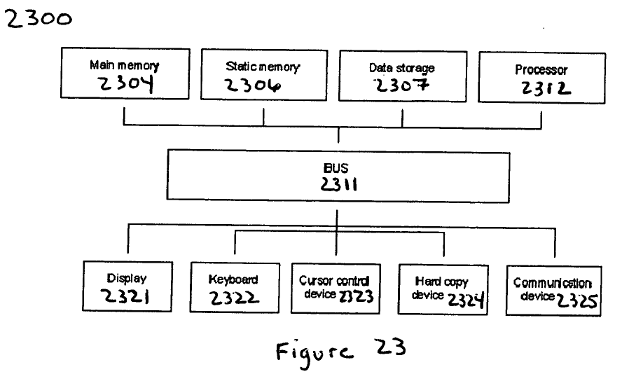

FIG. 23 is a block diagram of an exemplary computer system that may perform one or more of the operations described herein. Referring to FIG. 23, computer system 2300 may comprise an exemplary client or server computer system. Computer system 2300 comprises a communication mechanism or bus 2311 for communicating information, and a processor 2312 coupled with bus 2311 for processing information. Processor 2312 includes a microprocessor, but is not limited to a microprocessor, such as, for example, Pentium™, PowerPC™, etc. 22.

System 2300 further comprises a random access memory (RAM), or other dynamic storage device 2304 (referred to as main memory) coupled to bus 2311 for storing information and instructions to be executed by processor 2312. Main memory 2304 also may be used for storing temporary variables or other intermediate information during execution of instructions by processor 2312.

Computer system 2300 also comprises a read only memory (ROM) and/or other static storage device 2306 coupled to bus 2311 for storing static information and instructions for processor 2312, and a data storage device 2307, such as a magnetic disk or optical disk and its corresponding disk drive. Data storage device 2307 is coupled to bus 2311 for storing information and instructions.

Computer system 2300 may further be coupled to a display device 2321, such as a cathode ray tube (CRT) or liquid crystal display (LCD), coupled to bus 2311 for displaying information to a computer user. An alphanumeric input device 2322, including alphanumeric and other keys, may also be coupled to bus 2311 for communicating information and command selections to processor 2312. An additional user input device is cursor control 2323, such as a mouse, trackball, trackpad, stylus, or cursor direction keys, coupled to bus 2311 for communicating direction information and command selections to processor 2312, and for controlling cursor movement on display 2321.

Another device that may be coupled to bus 2311 is hard copy device 2324, which may be used for printing instructions, data, or other information on a medium such as paper, film, or similar types of media. Furthermore, a sound recording and playback device, such as a speaker and/or microphone may optionally be coupled to bus 2311 for audio interfacing with computer system 2300. Another device that may be coupled to bus 2311 is a wired/wireless communication capability 2325 to communication to a phone or handheld palm device.

Note that any or all of the components of system 2300 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An encoder for encoding a first set of data samples, the encoder comprising:
a waveform analyzer to determine a set of waveform parameters from a second set of data samples;
a waveform synthesizer to generate a set of predicted samples from the set of waveform parameters; and
a first encoder to generate a bit-stream based on a difference between the first set of data samples and the set of predicted samples.

2. The encoder defined in claim 1 wherein the waveform parameters comprise the amplitude, phase and frequency of one or more sinusoids.

3. The encoder defined in claim 2 wherein the waveform parameters are iteratively computed until a stop condition is met.

4. The encoder defined in claim 1 wherein the bitstream comprises a codeword.

5. The encoder defined in claim 4 wherein the codeword represents an index into a dictionary of codevectors.

6. The encoder defined in claim 4 wherein the codeword is an exact representation of the difference between the first set of data samples and the set of predicted samples.

7. The encoder defined in claim 1 wherein the set of data samples comprises audio samples.

8. The encoder defined in claim 1 further comprising a buffer to store the second set of data samples.

9. The encoder defined in claim 1 further comprising:
a first adder to generate a residual signal by subtracting the predicted signals from the input signal;
a decoder to decode the bit-stream into decoded signal samples;
a second adder to generate a decoded signal by adding the decoded residual signal to the set of predicted samples; and
a buffer to store the decoded signal samples for use by the waveform analyzer for generating other waveform parameters for use in generating another set of predicted samples.

10. The encoder defined in claim 1 wherein the encoder comprises a lossless entropy encoder; and further comprising an adder to generate difference between the first set of data samples and the set of predicted samples by subtracting the predicted signals from the first set of data, the entropy encoder entropy encodes the residual signal to produce the bit-stream.

11. The encoder defined in claim 1 further comprising:
decision logic, responsive to the input signal and the difference between the first set of data samples and the set of predicted samples, to generate a decision information;
a second encoder to operate on the first set of data samples;
a first switch, responsive to the decision information, to select an output of the first or second encoders to become part of the bit-stream;
first and second decoders associated with the first and second encoders, respectively, to decode outputs of the first and second encoders, respectively;
an adder to add the output of the second decoder with the predicted samples; and
a second switch to select an output from the first decoder or the output from the adder.

12. The encoder defined in claim 11 wherein the selected signal represents the decoded signal; and further comprising a buffer to store the selected signal for future use by waveform analyzer.

13. The encoder defined in claim 11 wherein the decision information comprises a decision flag, the decision flag being output with the bit-stream.

14. A method for encoding a first set of data samples, the method comprising:
determining a set of waveform parameters from a second set of data samples stored in a buffer;
generating a set of predicted samples from the set of waveform parameters; and
generating a bit-stream based on the difference between the first set of data samples and the set of predicted samples.

15. The method defined in claim 14 wherein the bit-steam comprises a codeword.

16. The method defined in claim 15 wherein the codeword represents an index into a dictionary of codevectors.

17. The method defined in claim 15 wherein the codeword is an exact representation of the difference between the first set of data samples and the set of predicted samples.

18. The method defined in claim 14 wherein the waveform parameters comprise the amplitude, phase and frequency of one or more sinusoids.

19. The method defined in claim 14 wherein determining the waveform parameters comprises iteratively computing waveform parameters until a stop condition is met.

20. The method defined in claim 14 wherein the first set of data samples comprises audio samples.

21. The method defined in claim 14 further comprising:
storing the first set of samples in a buffer, the buffer supplying the second set of samples.

22. The method defined in claim 14 further comprising:
generating a residual signal based on the difference between the first set of data samples and the set of predicted samples;
encoding the residual signal; and
obtaining a decoded residual signal by adding the decoded residual signal to the predicted samples.

23. The method defined in claim 22 wherein generating the waveform parameters is based on a previously decoded signal.

24. The method defined in claim 22 wherein encoding the residual signal comprises entropy encoding the residual signal.

25. The method defined in claim 14 further comprising:
storing the first set of samples in a buffer;
determining whether to quantize the first set of samples or the difference between the set of predicted samples and the second set of samples based on the performance of a waveform analyzer and waveform synthesizer as measured by the energy of the first set of samples and the energy of the difference;
quantizing the first set of samples or the difference between the set of predicted samples and the second set of samples based on results of determining which to quantize.

26. The method defined in claim 25 wherein determining whether to quantize the first set of samples or the difference between the set of predicted samples and the second set of samples comprises generating information indicating results of determining; and further comprising outputting the information with the bit-stream.

27. An article of manufacture having one or more recordable media storing instructions therein which, when executed by a system, cause the system to perform a method for encoding a first set of data samples, the method comprising:
determining a set of waveform parameters from a second set of data samples stored in a buffer;
generating a set of predicted samples from the set of waveform parameters; and
generating a bit-stream based on the difference between the first set of data samples and the set of predicted samples.

28. A decoder for decoding a first set of data samples, the decoder comprising:
a waveform analyzer to determine a set of waveform parameters from a second set of data samples;
a waveform synthesizer to generate a set of predicted samples from the set of waveform parameters;
a decoder to generate a set of residual samples from a bit-stream; and
an adder to add the set of predicted samples to the set of residual samples to obtain the first set of data samples.

29. The decoder defined in claim 28 wherein the waveform parameters comprise the amplitude, phase and frequency of one or more sinusoids.

30. The decoder defined in claim 28 wherein the bit-stream comprises a codeword.

31. The decoder defined in claim 30 wherein the codeword represents an index into a dictionary of codevectors.

32. The decoder defined in claim 28 wherein the waveform parameters are iteratively computed until a stop condition is met.

33. The decoder defined in claim 28 wherein the set of data samples comprises audio samples.

34. A method for decoding a first set of data samples, the method comprising:
determining a set of waveform parameters from a second set of data samples stored in a buffer;
generating a set of predicted samples from the set of waveform parameters;
generating a set of residual samples from a bit-steam; and
adding the set of residual samples to the set of predicted samples to obtain the first set of data samples.

35. The method defined in claim 34 wherein the waveform parameters comprise the amplitude, phase and frequency of one or more sinusoids.

36. The method defined in claim 34 wherein the bit-stream comprises one or more codewords.

37. The method defined in claim 36 wherein the codeword represents an index into a dictionary of codevectors.

38. The method defined in claim 34 wherein determining the waveform parameters comprises iteratively computing waveform parameters until a stop condition is met.

39. The method defined in claim 34 wherein the set of data samples comprises audio samples.

40. An article of manufacture having one or more recordable media storing instructions therein which, when executed by a system, cause the system to perform a method for decoding a first set of data samples, the method comprising:
determining a set of waveform parameters from a second set of data samples stored in a buffer;
generating a set of predicted samples from the set of waveform parameters;
generating a set of residual samples from a bit-steam; and
adding the set of residual samples to the set of predicted samples to obtain the first set of data samples.

41. A method for waveform matching prediction comprising:
comparing a number of samples from an input signal with waveforms or codevectors stored in a codebook; and
selecting the codevector within the codebook that is the closest to the input signal.

42. A method for sinusoidal prediction (SP) comprising:
analyzing a number of samples from some input signal to extract a number of sinusoids, specified by amplitudes, frequencies, and phases;
obtaining a subset of the sinusoids; and
forming a prediction based on the subset of sinusoids.

43. The method defined in claim 42 where sinusoidal analysis is performed using an analysis-by-synthesis method.

44. The method defined by claim 42 where the steadiness of a sinusoid is verified through the use of a history buffer, in which the information regarding the extracted sinusoids in the past frames are stored.
